(19) United States
(12) Patent Application Publication
(10) Pub. No.: US 2003/0162154 A1
(43) Pub. Date: Aug. 28, 2003

(54) Interconnectable toy letters and numbers

(76) Inventor: Susan Hinshaw, Norton Shores, MI (US)

Correspondence Address: GREENBERG TRAURIG, P.C., 77 WEST WACKER DRIVE, CHICAGO, IL, 60601-1732, US

(21) Appl. No.: 10/082,457

(22) Filed: Feb. 25, 2002

(51) Int. Cl. G09B 1/36

(52) U.S. Cl. 434/171

(57) ABSTRACT

The present invention is directed to a set of interconnecting letterform segments, in the discernable shapes of letters, numerals, and mathematical operators. Each segment comprises a length of body material defining an inner region having an access opening to enable the letterform segments to be releasably coupled with other segments—to enable the linked spelling of words and the linked construction of mathematical expressions.

### BACKGROUND OF THE INVENTION

1. Field of the Invention

The present invention relates in general to interconnecting letterform segments and, more particularly, to a children's toy comprising interconnecting geometrical shapes in the form of letters, numbers and mathematical operators.

2. Background Art

A child's cognitive development improves in direct proportion to the sensory stimulation he or she receives as an infant. As a result, manufacturers of children's toys often seek to develop interactive toys for infants which promote strong cognitive development. One example of such a toy currently known in the art comprises interconnecting or interlinking shapes. These toys typically have simple geometric or animal shapes and employ simple linking mechanisms.

It is also well known in the art that infants may implicitly remember shapes, colors, and other sensory stimuli even when infants are unable to explicitly recall specific stimuli. This implicit memory improves an infant's ability to learn as it grows. Because of this implicit memory, infants who are frequently exposed to letters and numbers develop stronger reading skills earlier in life than their peers who are not similarly exposed.

Thus, an infant's cognitive development may be further accelerated if the cognitive skill of combining letters into words and/or numbers into mathematical expressions can be implicitly taught to infants at an early stage in life.

It is thus an object of this invention to provide interactive children's toys having the shapes of letters, numbers, and mathematical operators, which can be interlinked to form worded and mathematical expressions, thereby allowing an infant to experiment with letterforms by linking them into chains while exploring them tactilely, visually, and orally.

### SUMMARY OF THE INVENTION

The present invention is directed to a children's toy comprising a plurality of individual segments which may be releasably coupled together to form a chain of segments. Each segment is an integral length of body material preferably surrounding at least one inner region. The inner region is completely enclosed by the body material, except for an access opening in the body material. A first segment may be releasably coupled with a second segment by inserting the second segment into the access opening of the first segment. Each segment is in the form of a letterform, which includes letters, numerals, or mathematical operators. When successive segments are linked together in series, they may form words or mathematical expressions for infants to explore.

In one embodiment, the inner region is in the discernable shape of a letterform, as opposed to the body material itself being in the shape of a discernable letterform. Likewise, in another embodiment, the body material itself, rather than the inner region, may be in the shape of a discernable letterform.

In yet other embodiments, some of the individual segments may include more than one inner region, with each additional inner region having a corresponding additional access opening.

In one preferred embodiment, an access opening may be formed between the two ends of the length of body material. Alternatively, the access opening may also be formed between one end of the length of body material and another portion of the body material. In either form, the access opening is no wider than the cross-sectional width of the lengths of body material.

The body material may further include a series of ribs which serve to retain coupled segments in a linked configuration. Protrusions and depressions in the body material may be provided to present additional stimulation for infants. Some segments may further have substantially planar reinforcement sections which serve to provide additional rigidity to the body material of each reinforced segment.

In a preferred embodiment, the letterform segments may be manufactured from a non-toxic plastic material being pliable yet having a sufficient hardness to withstand the teething action of an infant, and may also be manufactured in various colors.

### BRIEF DESCRIPTION OF THE DRAWINGS

FIG. 1 is an elevated front view of a plurality of letterform segments in the form of alphabet letters, which are linkable, in series, to form many different words.

FIG. 2 is an elevated front view of a plurality of letterform segments in the form of numerals and mathematical operators, which are linkable, in series, to form many different mathematical expressions.

FIG. 3 is an elevated front view of a letterform letterform segment where the body material is in the shape of a discernable letterform.

FIG. 4 is an elevated front view of a letterform letterform segment where the inner region is in the shape of a discernable letterform.

FIG. 5 is an elevated front view of a letterform letterform segment where the letterform has multiple access openings.

FIG. 6 is an elevated front cross-sectional view of two letterform letterform segments showing the configuration of the segments before coupling.

FIG. 7 is a elevated front cross-sectional view of two letterform letterform segments showing the segments in position for coupling.

FIG. 8 is a elevated front cross-sectional view of two letterform letterform segments showing the positions of the segments during coupling.

FIG. 9 is a elevated front cross-sectional view of two letterform segments showing the positions of the segments after coupling.

FIG. 10 is an elevated side view of one of the letters of FIG. 4

FIG. 11 is an elevated front view of several letterform segments linked together to form a word.

FIG. 12 is an elevated front view of several letterform segments linked together to form a mathematical expression.

FIG. 13. is an elevated side view of a letterform segment with surface protrusions.

FIG. 14 is an elevated side view of a letterform segment with ribs.

FIG. 15 is an elevated side view of a letterform segment having a substantially planar reinforcement section.

### DETAILED DESCRIPTION OF THE INVENTION

While this invention is susceptible to embodiment in many different forms, the drawings show several specific embodiments with the understanding that the present disclosure is to be considered as an exemplification of the principles of the invention and is not intended to limit the invention to the embodiments illustrated.

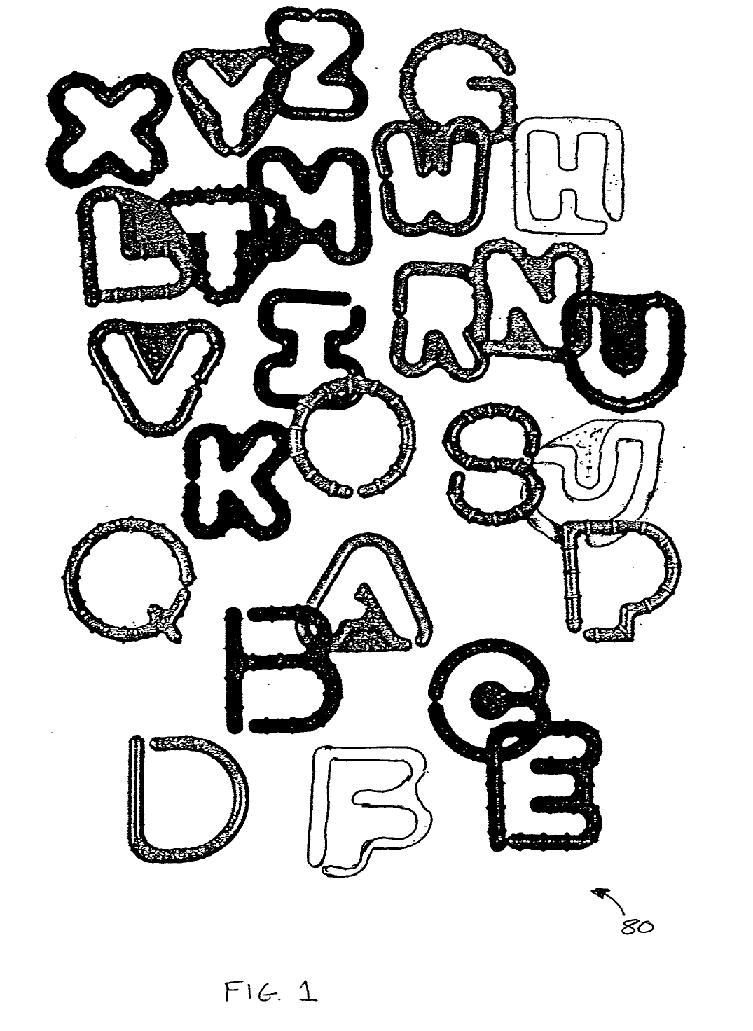

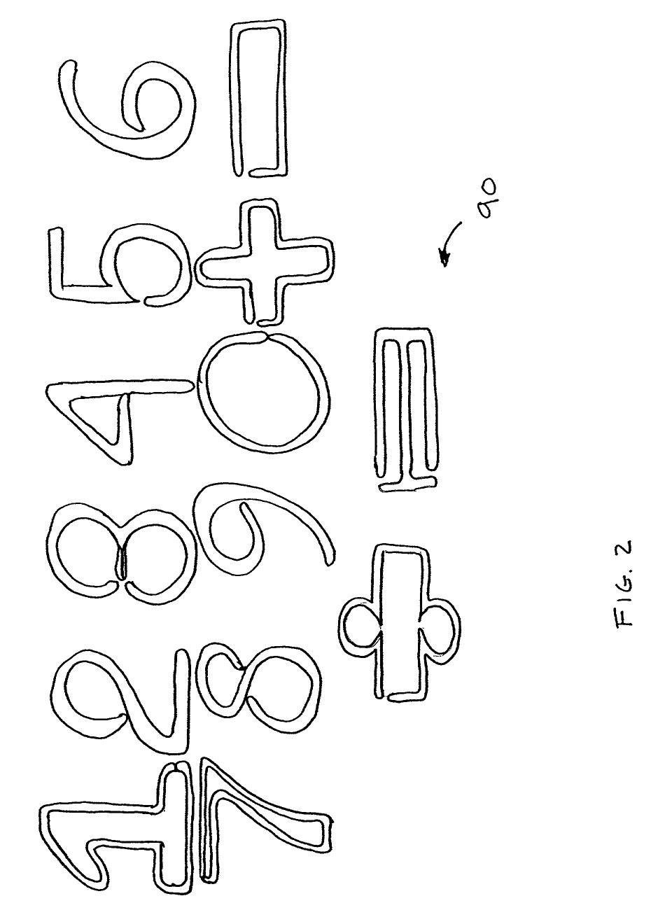

FIGS. 1-2 illustrate several embodiments of letterform letterform segments in accordance with the present invention. FIG. 1 illustrates an embodiment 80 with respect to all of the letters of the alphabet, while FIG. 2 illustrates an embodiment 90 with respect to the numerals one through zero, as well as the mathematical operators including addition, subtraction, multiplication, division, and an equal signs.

FIGS. 3-5 show various embodiments of letterform segments in more detail. FIG. 3 illustrates a first embodiment of a letterform segment 100 in the form of the letter “Q”. The segment 100 comprises a length of body material 102, having a first end 104 and a second end 106. The body material 102 is preferably manufactured of a single, integral length of plastic or other suitable body material. The segment 100 defines a substantially closed shape with the exception of an access opening 108 between the first end 104 and the second end 106 of the body material 102. The access opening 108 provides access to the inner region 110 of the segment 100, which is substantially enclosed by the body material except for the access opening 108. The body material 102 of segment 100 is in the discernable shape of a letterform, namely the alphabet letter “Q”.

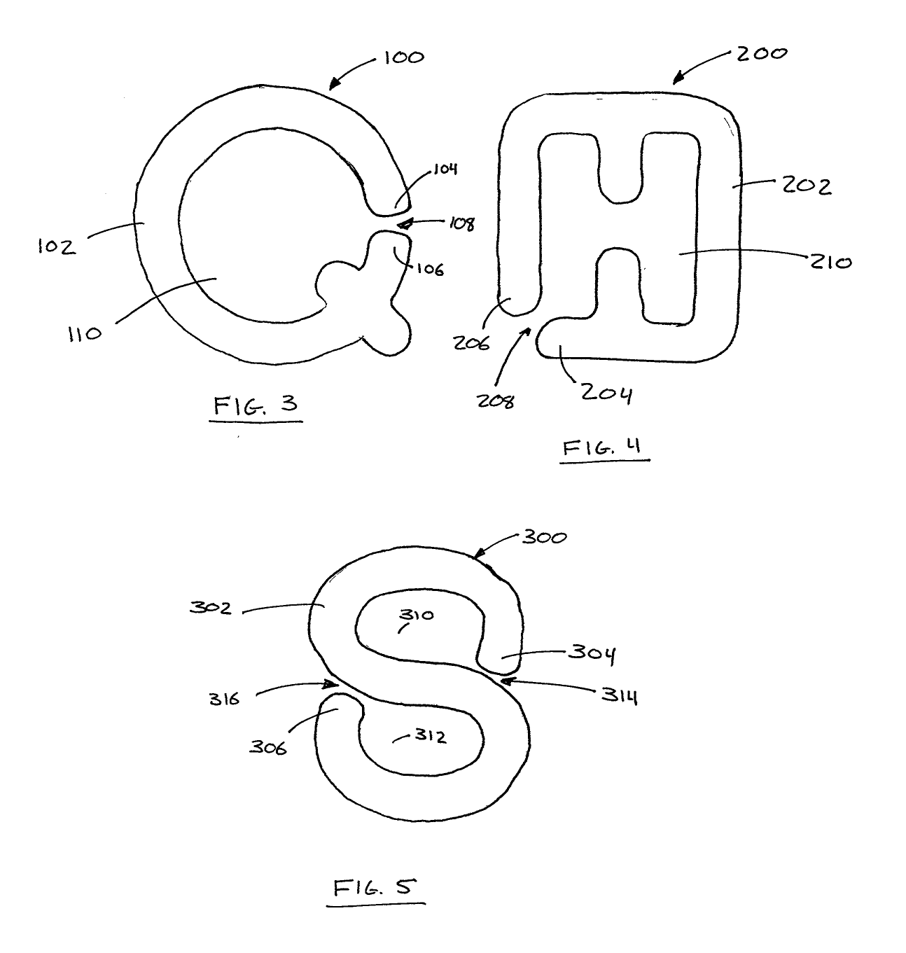

FIG. 4 illustrates a second embodiment of a letterform segment 200 in the form of the capital letter “H”. The segment 200 also comprises a length of body material 202, having a first end 204 and a second end 206, and an access opening 208 between the first end 204 and the second end 206. However, in this segment, the body material 202 is not itself in the discernable shape of letterform; rather, it is the inner region 210 that is in the discernable shape of letterform, namely the alphabet letter “H”.

FIG. 5 illustrates a third embodiment of a letterform segment 300, in the form of the letter “S, comprising a length of body material 302 having a first end 304 and a second end 306. The length of body material 302 defines a first inner region 310 and a second inner region 312. A first access opening 314, between the first end 304 and a portion of the length of body material 302, corresponds to the first inner region 310. Likewise, a second access opening 316, between the second end 306 and a portion of the length of body material 302, corresponds to the second inner region 312.

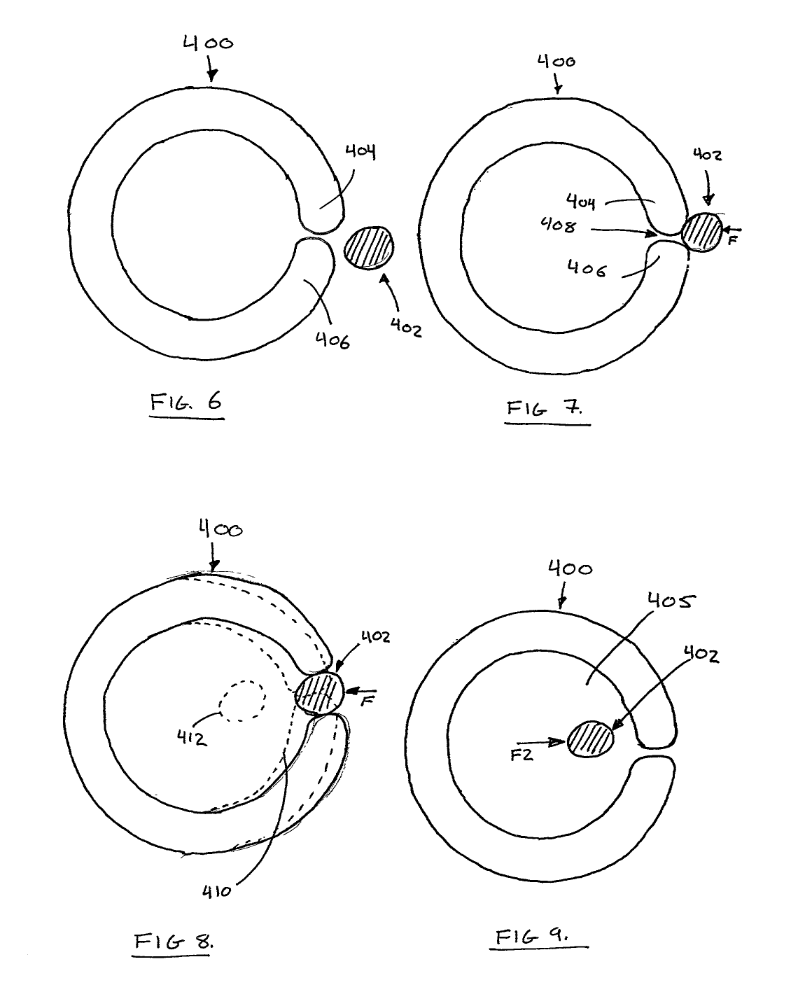

FIGS. 6-9 illustrate how a first letterform segment 400, in the shape of the letter “O”, and a second letterform segment 402, shown in cross-section, are releasably coupled. FIG. 6 illustrates a first end 404, a second end 406, and an access opening 408 of the first letterform segment 400. The second letterform segment 402 is disposed immediately adjacent to the access opening 408 of the first letterform segment 400.

Turning to FIG. 7, the second segment 402 has been brought into proximity with the access opening 408 of the first segment 400. In the preferred embodiment, the width of the access opening 408 is less than or equal to the cross-sectional width of the body material of the second segment 402. Thus the body material of the second segment 402 is preferably too wide to fit through the access opening 408. However, as force F is applied to the second segment 402, the first segment 400 begins to bend, widening the access opening 408, as shown in FIG. 8. Once the access opening is wide enough, the second segment 402 passes through the access opening 408 and the first segment 400 snaps back into its original shape, as indicated by the dashed lines 410, 412 in FIG. 8. FIG. 9 illustrates the second segment 402 having been fully inserted into the inner region 405 of the first segment 400. Because the width of the access opening 408 is preferably less than the width of the body material of the second segment 402, the segments 400, 402 will remain releasably coupled until a second force F2 is applied.

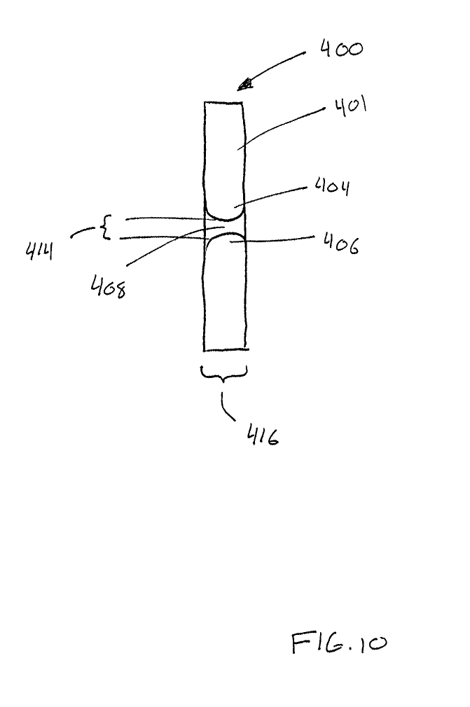

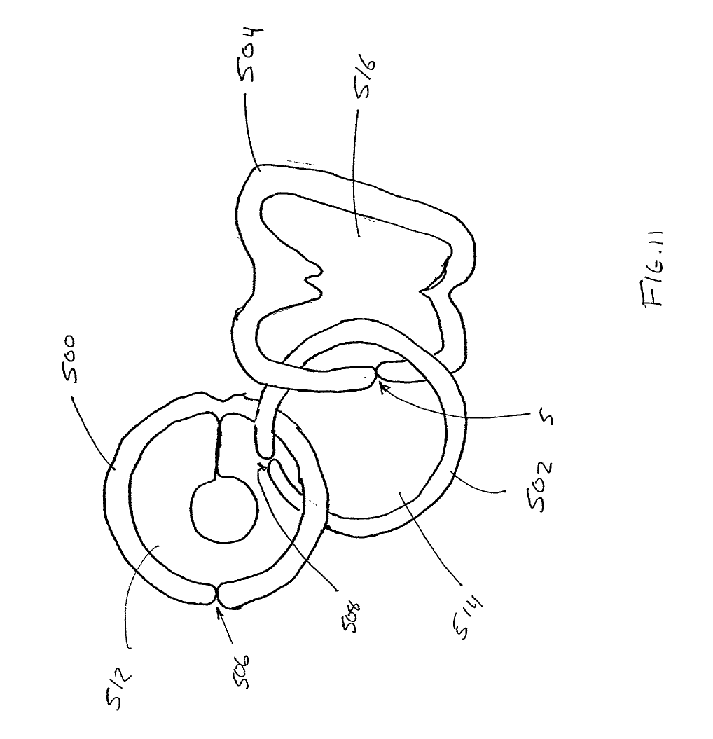

FIG. 10 illustrates the preferred width of the access opening 408. FIG. 10 is an elevated side view of the first segment 400 of FIGS. 6-9. The segment 400 is made of a body material 401 having a first end 404 and a second end 406, separated by an access opening 408. The width 414 of the access opening 408 is defined by the distance between the first end 404 an the second end 406. The width 416 of the body material 401 of the segment 400 is preferably greater than or equal to the width 414 of the access opening 408.

The letterform segments each have the form of discernable letterforms, which include alphabet letters, numerals, or mathematical operators. Thus, expressions can be formed by combining the appropriate letterform segments together in series. Thus, the word “COW” may be spelled by combining the letterform segments representing the letters “C,” “O” and “W”, as shown in FIG. 11.

FIG. 11 shows a first letterform segment 500 in the shape of the letter “C”, a second letterform segment 502 in the shape of the letter “O”, and a third letterform segment 504 in the shape of the letter “W”. Each letterform segment 500, 502, 504 has a respective access opening 506, 508, 510. Each segment 500, 502, 504 additionally has a respective inner region 512, 514, 516. A portion of the first segment 500 passes through the inner region 514 of the second segment 502. Likewise, a portion of the second segment 502 passes through the inner region 512 of the first segment 500. Thus, the first segment 500 and the second segment 502 are releasably coupled.

In addition, a portion of the second segment 502 passes through the inner region 516 of the third segment 504, while a portion of the third segment 504 passes through the inner region 514 of the second segment 502. Thus, the second segment 502 and the third segment 504 are also releasably coupled. The segments 500, 502, 504, as assembled in series spell out the word “COW”.

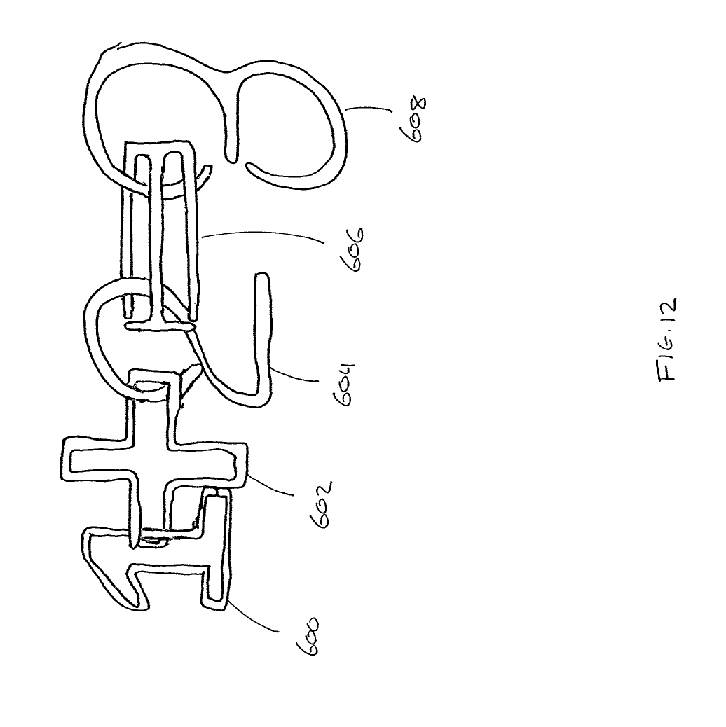

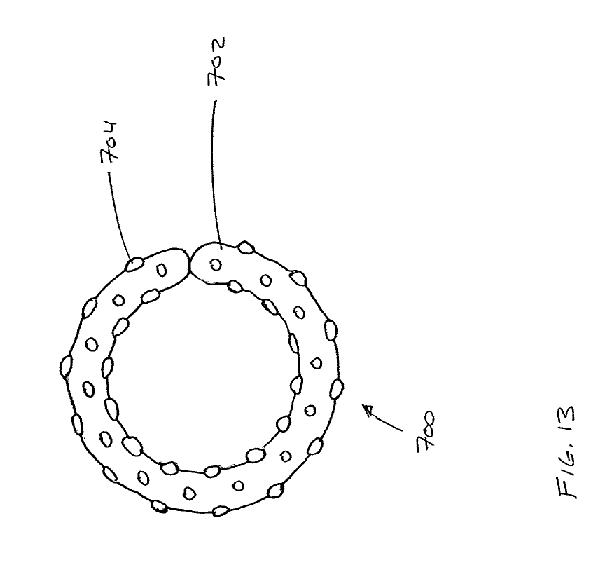

FIG. 12 illustrates how a series of letterform segments of numerals and operators are combined to form a mathematical expression. A first segment 600 in the form of the numeral “1” is releasably coupled to a second segment 602 in the form of the mathematical operator “+”. The second segment 602 is likewise releasably coupled with a third segment 604, in the form of the numeral “2”. The third segment 604 is further releasably coupled with a fourth segment 606, in the form of the mathematical operator “=”. Finally, the fourth segment 606 is releasably coupled with the fifth segment 608, in the shape of the numeral “3”. When combined in series as shown in FIG. 12, the segments form the mathematical expression “1+2=3”.

Once combined, the segments will remain releasably linked until pulled apart. The ability to combine segments allows infants to become familiar with the shapes of various letters and numbers and, as the infants grow older, introduces them to the concepts of combining letters to form words and combining numbers to form expressions.

The letterform segments are preferably made of a non-toxic plastic material safe for use around small children. Specifically, the letterform segments are made of a material a child could safely put into his or her mouth. In addition, the segments are sized so as to be too large for a child to swallow. The segments are also preferably made from a durable, substantially rigid, but pliable plastic capable of withstanding the elastic deformation that occurs during the coupling and uncoupling of the segments, as well as the teething action of an infant. Various body sections may also be manufactured from plastics in various colors.

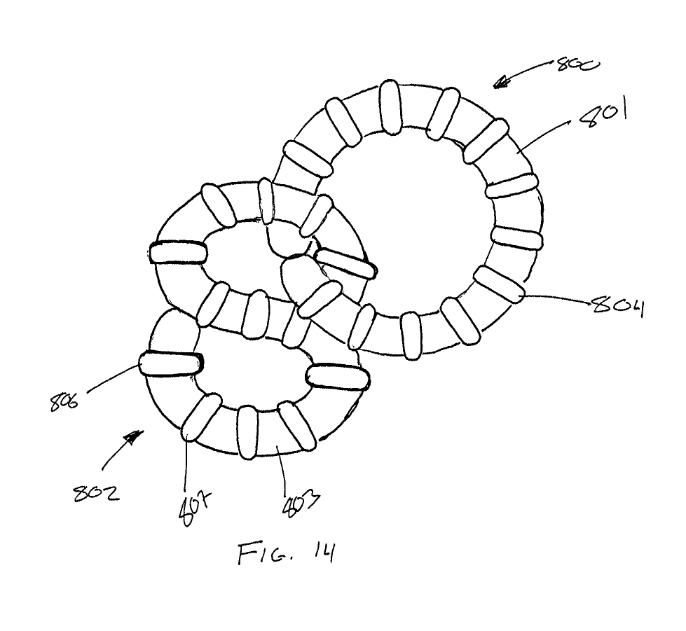

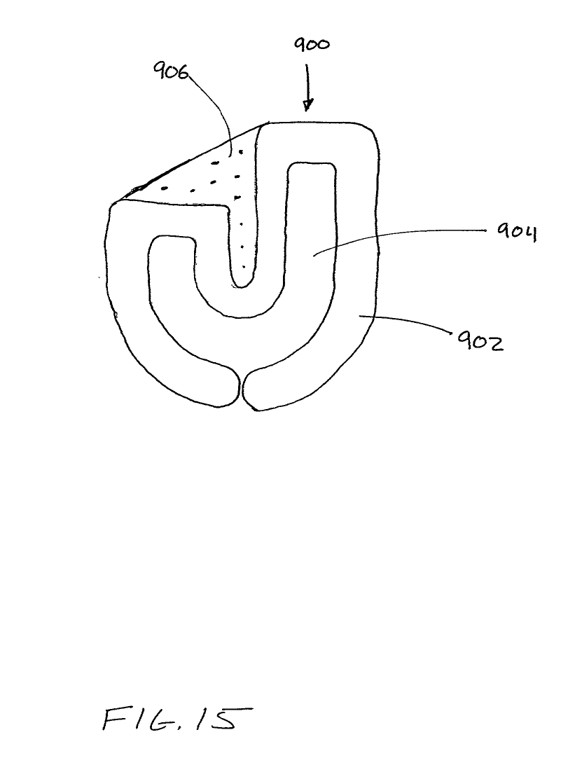

The letterform segment may further include surface textures as illustrated in FIGS. 13 and 14. FIG. 13 illustrates a letterform segment 700 in the shape of the letter “O”. The segment 700 is made of a length of body material 702 having a series of protrusions 704. Yet another embodiment may incorporate depressions instead of protrusions, or may also incorporate a combination of protrusions and depressions.

FIG. 14 illustrates first letterform segment 800 in the form of the letter “O” and a second letterform segment 802 in the form of the letter “S”. The first segment 800 is comprised of a length of body material 801 having a series of ribs 804. Similarly, the second segment 802 is comprised of a length of body material 803 having a series of large ribs 806 and series of small ribs 807. The large ribs 806 and small ribs 807 on the second segment 802 interfere with the ribs 804 on the first segment 801, thus maintaining the relative orientation of the two segments 800, 802 and preventing the two segments 800, 802 from becoming accidentally uncoupled.

FIG. 15 illustrates a letterform segment 900 having a substantially continuous, substantially integral length of body material 902, an inner region 904, and a reinforcement section 906. The reinforcement section 906 is integral with the length of body material 902 and substantially co-planar with the letterform 900, which is in the shape of the letter “J”. The reinforcement section 906 imparts additional rigidity to the letterform segment, thus making the segment more durable and less likely to break.

The foregoing description and drawings merely explain and illustrate the invention, and the invention is not limited thereto except insofar as the amended claims are so limited as those skilled in the art having the present disclosure before them will be able to make modifications and variations therein without departing from the scope of the invention.

What is claimed is:

1. A children's toy of pre-formed, substantially closed, letterform segments for successive linking, comprising:
a plurality of letterform segments, at least two of which include a substantially continuous, substantially integral, length of body material defining a discernable shape;
the substantially continuous, substantially integral, lengths of body material substantially enclosing at least one inner region substantially circumscribed by said body material;
the substantially continuous, substantially integral, lengths of body material further having at least one first end, at least one second end, and at least one access opening therebetween, the at least one access opening allowing linked coupling by insertion of another of the of the letterform segments;
the geometrical shape of each of the letterform segments being in the form of a substantially rigid one of an alphabet letter, numeral, and mathematical operator, serving as an individual indicia component of each letterform segment;
said at least two letterform segments capable of being releasably linked via coupling with each other in series, to form at least one of worded and mathematical expressions by slidably inserting the body material of a first letterform segment through the access opening and into the inner region of a second letterform segment.

2. The children's toy of claim 1 in which said at least one substantially enclosed inner region defines the discernable letterform shape of one of said alphabet letter, numeral, and mathematical operator.

3. The children's toy of claim 1 in which said substantially continuous, substantially integral length of body material defines the discernable letterform shape of one of said alphabet letter, numeral, and mathematical operator.

4. The children's toy of claim 1 in which a letterform segment further includes at least two substantially enclosed inner regions, said at least two substantially enclosed inner regions describing at least two access openings, respectively.

5. The children's toy of claim 1, in which the access opening is formed between the at least one first end and the at least one second end of the body material.

6. The children's toy of claim 1, in which the access opening is formed between one of the at least one first end and at least one second end, and another portion of the body material.

7. The children's toy of claim 1, in which the access opening has a width no greater than a cross-sectional width of the substantially rigid body material.

8. The children's toy of claim 1 in which the body material further includes a series of ribs for preventing accidental de-coupling while maintaining the relative positions of the linked segments to portray said desired expression.

9. The children's toy of claim 1 in which the body material further includes a surface texture including at least one of protrusions and depressions for teething stimulation.

10. The children's toy of claim 1 in which a letterform segment further includes a substantially planar reinforcement section between portions of the substantially continuous, substantially integral, length of body material, for imparting additional rigidity to the segment.

11. The children's toy of claim 1 in which said body material is formed from a nontoxic plastic material being pliable yet having a sufficient hardness to withstand the teething action of an infant.

12. The children's toy of claim 1 in which said plurality of letterform segments further comprises letterform segments being formed from materials in assorted colors.
